(19) United States
(12) Patent Application Publication
(10) Pub. No.: US 2014/0230843 A1
(43) Pub. Date: Aug. 21, 2014

(54) MULTI-TOOTH FLOSSER

(71) Applicant: Samy Saadi Achour, Encinitas, CA (US)

(72) Inventor: Samy Saadi Achour, Encinitas, CA (US)

(21) Appl. No.: 13/968,346

(22) Filed: Aug. 15, 2013

Related U.S. Application Data
(60) Provisional application No. 61/765,724, filed on Feb. 16, 2013.

(51) Int. Cl. A61C 15/04

(52) U.S. Cl. CPC A61C 15/046
USPC 132/323

(57) ABSTRACT

A multi-tooth flosser allows a user to floss simultaneously several spaces between the user's teeth. In an embodiment, the device includes an assembly of multiple pieces, allowing the device to be adjustable and adapted to the mouths of different users. The user adjusts the placement of the stringed material through movement of floss receivers along an arched groove, with the dental floss being attached to the floss receivers. In this way, the stringed material is aligned with the positions of the spaces between the user's teeth. An impression of the user's teeth made in a cavity filled with impressionable material into which the user bites guides the adjustment of the floss receivers.

### CROSS-REFERENCE TO RELATED APPLICATION

This application claims priority to, U.S. Provisional Patent Application Ser. No. 61/765,724, entitled MULTI TOOTH FLOSSER, filed on Feb. 22, 2013. The disclosure of the foregoing patent document is incorporated herein by reference as if fully set forth herein, including Specification, Figures, Claims, Tables, and all other matter (if present).

### FIELD OF THE INVENTION

This document relates generally to the field of dental hygiene, and more particularly, to dental flossing tools.

### BACKGROUND

Flossing teeth is a necessary hygienic procedure that people need to do to maintain dental health. The point of flossing teeth is to clear out food debris and plaque between the teeth, and to decrease bacteria present in the mouth. The American Dental Association (ADA) recommends brushing twice a day and flossing once a day. Not flossing on a regular basis can lead to tooth decay and gum disease. There are several types of dental floss, including waxed and unwaxed, flavored and unflavored, and regular and tape types of floss. These existing teeth flossing devices that consumers use today, however, allow flossing areas between teeth one at a time, which is time consuming. Also, if not done correctly, dental flossing can be painful for the fingers. Thus, although the benefits of flossing have been documented, flossing is not practiced as much as is desirable. Several flossing products have been invented to make flossing easier, less time consuming, and less painful.

One type of flossing device is the dental pick. It can pick at the gums and areas between teeth, to remove plaque. It is less painful for the fingers and more efficient than flossing.

There also exist stemmed flosser devices. They typically have a bow-like tool with floss tightened at the ends thereof. These device allow the user to reach deep between the teeth and below the gum line, to remove plaque.

A water pick is another type of device. Water picks may have a long cylinder bottom that holds the water, and a thin head to shoot the water between the user's teeth.

Several flossing devices include a simple flossing stem with extra options. One such flosser includes a flossing advance wheel, which provides clean floss every time the device is used.

One drawback of all these products is that they are used to clean one tooth (or, more precisely, one between teeth area) at a time.

It is desirable to improve the devices used for cleaning the areas between the teeth.

### SUMMARY

A need exists in the art for devices that would allow a user to floss several teeth at one time. A need in the art exists for multi-tooth flossing devices that are adjustable to the dental anatomy of different users. Embodiments of the present invention are directed to apparatuses and articles of manufacture that may satisfy one or more of these and possibly other needs.

Selected dental hygiene tools described in this document allow users to floss simultaneously several or even all in-between-teeth areas of a jaw. The tools may be adjustable or user-configurable, so that they can be adapted to the different dental anatomies of a variety of users.

In an embodiment, a multi-tooth flosser includes a base with portions defining a cavity; material in the cavity showing locations of in-between teeth gaps of a user; a main flosser arch substantially corresponding to an outline of gums of a jaw, the main flosser arch having portions defining a first groove, portions defining a second groove, the second groove opposing the first groove, the main flosser arch also having a first side and a second side opposite the first side; a first plurality of floss receivers inserted into the first groove and a second plurality of floss receivers inserted into the second groove; flossing material stretched between the floss receivers of the first plurality of floss receivers in the first groove and floss receivers of the second plurality of floss receivers in the second groove; and a secondary flosser arch substantially corresponding to the outline of the gums. The floss receivers of the first and second pluralities of floss receivers are adjusted along the first groove and the second groove so that the flossing material is stretched substantially to coincide with the locations of the in-between teeth gaps in the material. The base is secured to the first side of the main flosser arch, and the secondary flosser arch is secured to the second side of the main flosser arch.

In aspects, the base of the multi-tooth flosser also has portions defining a base through hole; the main flosser arch also has a first set of spring action couplers configured for hole latching, and a second set of spring action couplers configured for hole latching; the secondary flosser arch also has portions defining secondary flosser arch through hole; the first sets of spring action couplers is latched in the base through hole to secure the base to the main flosser arch; and the second set of spring action couplers is latched in the secondary flosser arch through hole to secure the secondary flosser arch to the main flosser arch.

These and other features and aspects of the present invention will be better understood with reference to the following description, drawings, and appended claims.

### BRIEF DESCRIPTION OF THE FIGURES

FIG. 1 illustrates selected features of a holder of impressionable material of a multi-tooth flosser;

FIG. 2A illustrates selected features of a main flosser arch of the multi-tooth flosser;

FIG. 2B illustrates selected features of a secondary flosser arch of the multi-tooth flosser;

FIG. 2C illustrates coupling of the main flosser arch and the secondary flosser arch of the multi-tooth flosser;

FIG. 3A illustrates selected features of a floss receiver of the multi-tooth flosser;

FIG. 38 illustrates insertion of the floss receiver into the main flosser arch;

FIG. 4A illustrates assembly of the multi-tooth flosser; and

FIGS. 4B and 4C illustrate selected features of the assembled multi-tooth flosser.

### DETAILED DESCRIPTION

In this document, the words “embodiment,” “variant,” and example refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar expressions and phrases are used to indicate one of a number of different possible embodiments. The number of possible to embodiments is not necessarily limited to two or any other quantity. Characterization of an item as “exemplary” and the use of similar characterizations mean that the item is used as an example. Such characterization of an embodiment does not necessarily mean that the embodiment is a preferred embodiment; the embodiment may but need not be a currently preferred embodiment. All embodiments are described for illustration purposes and are not strictly limiting.

Other and further definitions and clarifications of definitions may be found throughout this document.

Reference will now be made in detail to several embodiments that are illustrated in the accompanying drawings. Same reference numerals are used in the drawings and the description to refer to the same apparatus elements and method steps. The drawings are in simplified form, not to scale, and omit apparatus and articles of manufacture elements and method steps that can be added to the described apparatuses, articles of manufacture, and methods, while possibly including certain optional elements and steps. For purposes of convenience and clarity only, directional terms, such as top, bottom, left, right, up, down, over, above, below, beneath, rear, and front, may be used with respect to the accompanying drawings. These and similar directional terms should not be construed to limit the scope of the invention in any manner. Note also that the words such as “connect,” “couple,” and similar terms with their inflections do not necessarily denote direct and immediate connections, but also include connections through intermediate elements or devices.

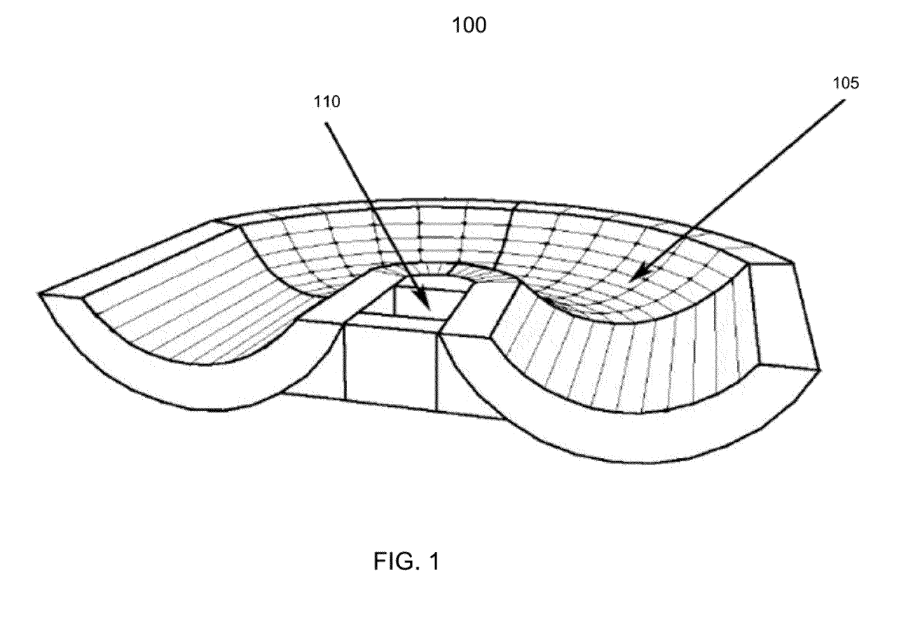

Referring more particularly to the drawings, FIG. 1 shows a holder 100 of impressionable material, including portions defining a cavity 105 and through hole 110. The cavity 105 is designed to receive impressionable material, such as materials used for making customized dental trays used for tooth whitening/bleaching. The holder 100 thus holds the impressionable material that the user presses his or her teeth onto to create an engraved image of his or her upper or lower teeth and possibly gums. Through hole 110 is used for coupling the holder 100 to other multi-tooth flosser components, as will be described below.

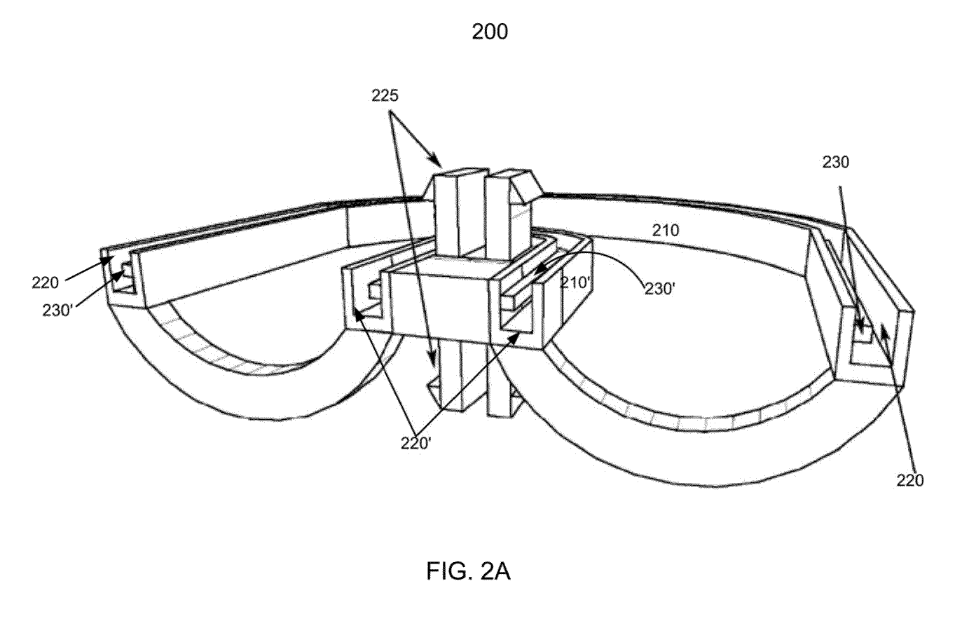

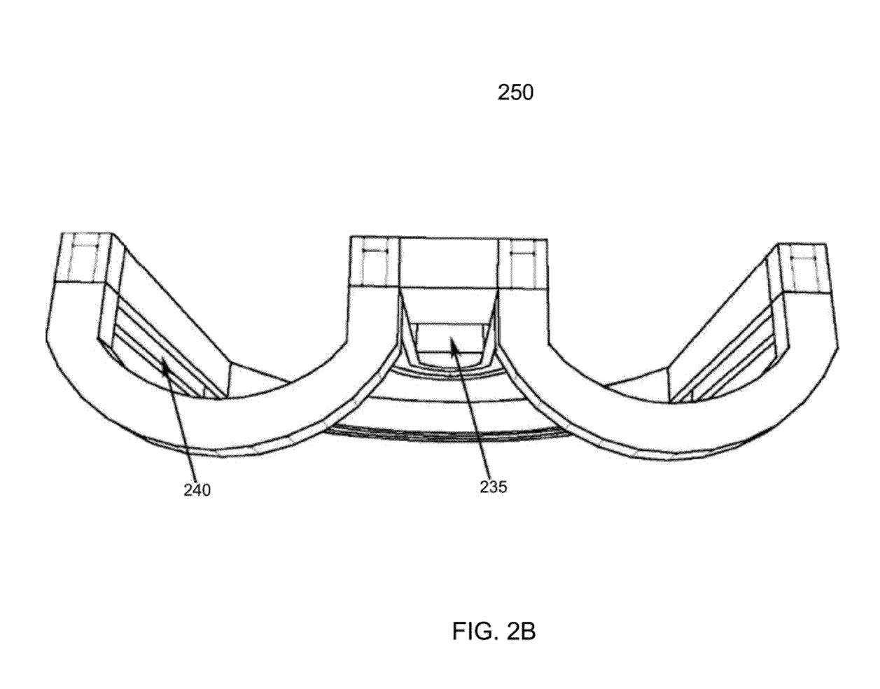

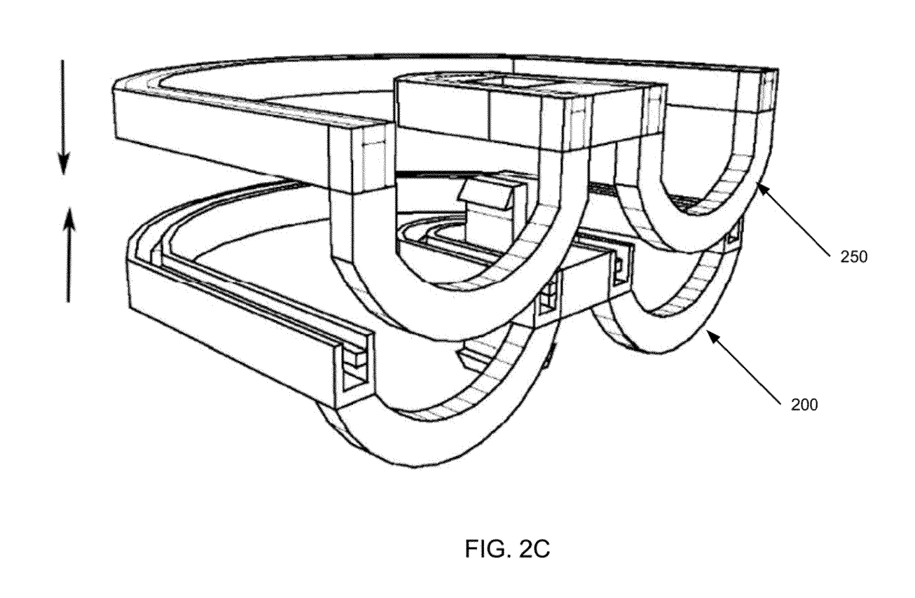

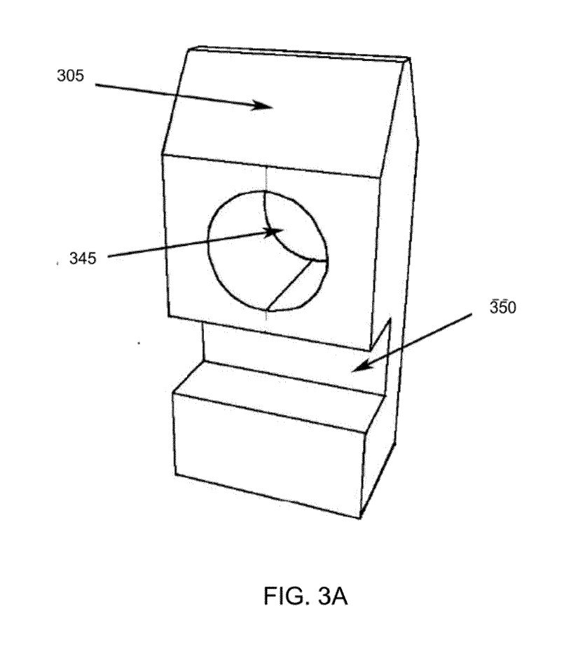

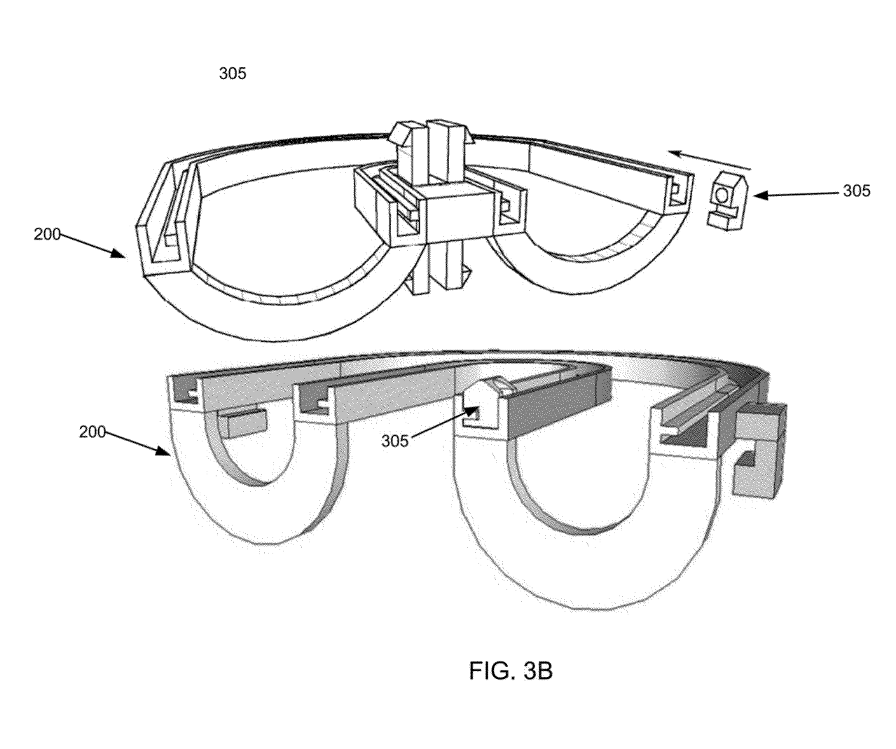

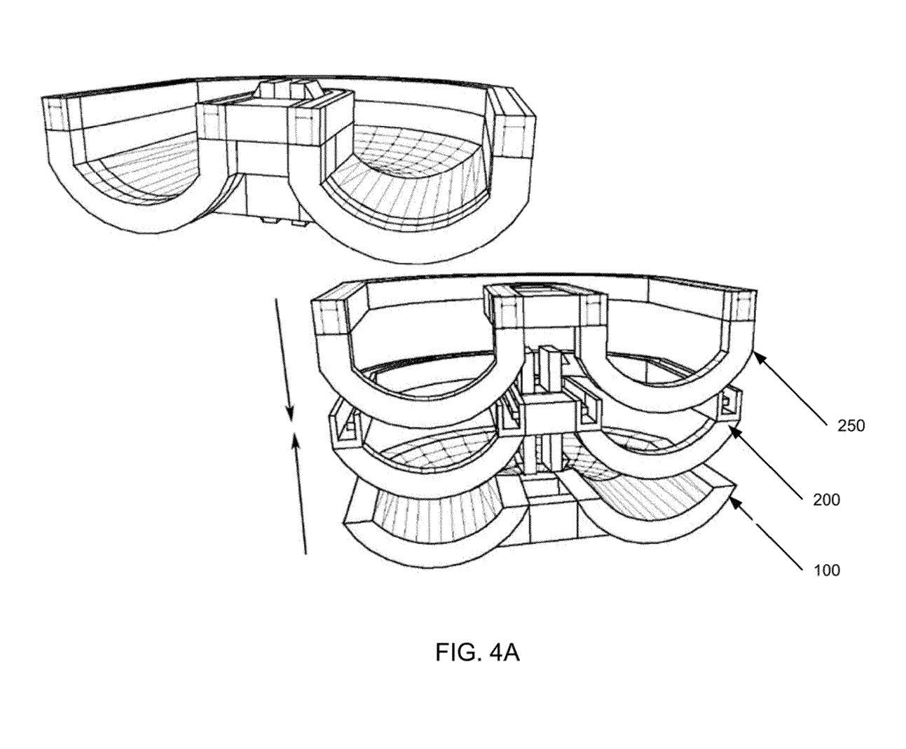

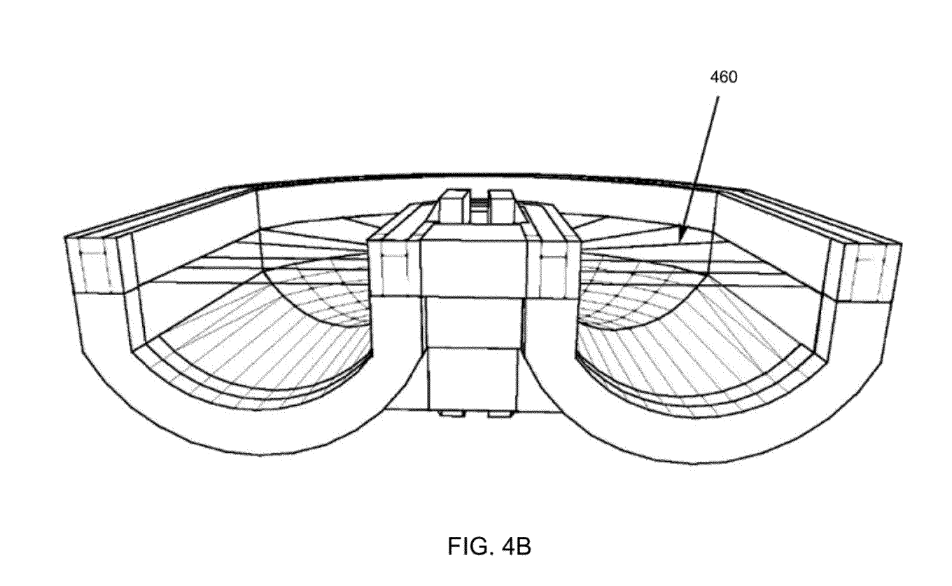

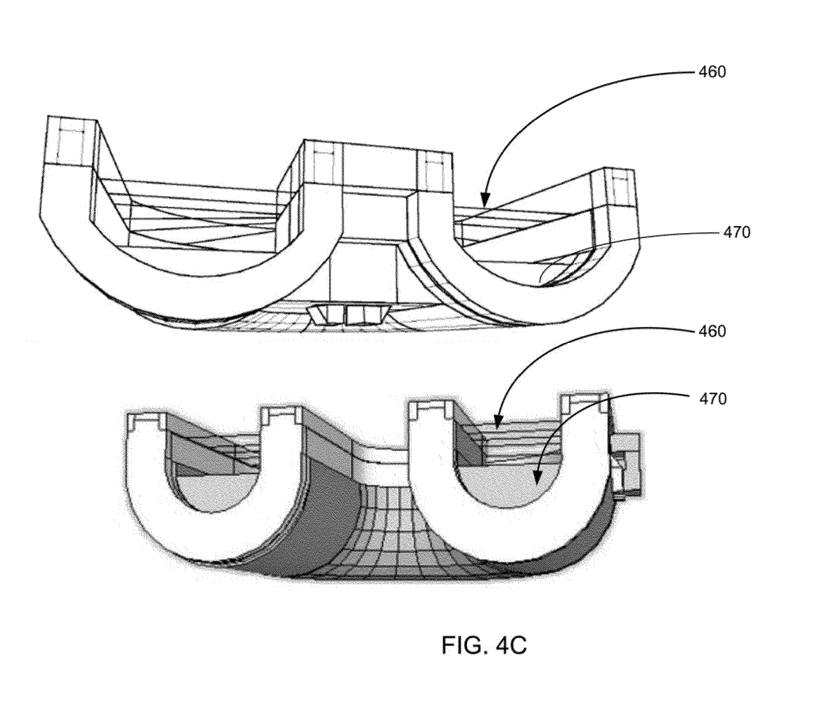

FIG. 2A shows a main flosser arch 200, which goes on top of the holder 100, and is configured to contain floss receivers 305 (described below in relation to FIG. 3A) and allow the user to adjust the placements of the floss receivers 305 along the length of grooves 220 and 220′ in arched frames 210 and 210′. Spring action couplers 225 protrude in both directions (up and down in this Figure), to facilitate attachment of the main flosser arch 200 to other multi-tooth flosser components. The spring action of the couplers 225 refers to the ability of the couplers to come closer to each other under pressure exerted at their ends (when the ends are pushed together)), and then to spring back into the initial position. The main flosser arch 200 also includes rails 230 and 230′ extending along the grooves 220 and 220′, respectively, for containing the floss receivers 305 and allowing the floss receivers 305 to be moved along the respective grooves 220/220′.

FIG. 2B shows a secondary flosser arch 250, including a groove 240 extending along the arch, and portions defining a through hole 235, which is used for coupling the secondary flosser arch 250 to other multi-tooth flosser components. The secondary flosser arch 250 goes on top of the main flosser arch 200 and secures the main flosser arch 200 in place so that the combined structure is secure and the arches 200 and 250 do not easily move with respect to each other.

FIG. 2C shows main flosser arch 200 and the secondary flosser arch 250 in the process of being pushed together so that one set of the spring action couplers 225 (the top set in this Figure) of the main flosser arch 200 goes into the through hole 235, and as the spring action couplers 225 expand and latch, the main flosser arch 200 and the secondary flosser arch 250 become secured to each other. In a similar way, the holder 100 is pushed onto the main flosser arch 200 so that the other set of the spring action couplers 225 (the bottom set in this Figure) are inserted into the through hole 110 and, as the spring action couplers 225 expand and latch, the holder 100 becomes secured to the main flosser arch 200.

FIG. 3A shows one of the floss receivers 305 mentioned above. The floss receiver 305 includes portions defining a hole 345 for receiving stringed dental floss. The floss receiver 305 also includes portions defining an indent 350, which is designed to engage with the rail 230 or 230′ of the main flosser arch 200, so that the floss receiver 305 can slide along the groove 220/220′ and the rail 230′ in the direction of the respective groove 220/220′, and thus allow the user to align the dental floss in the hole 345 with different between teeth areas (teeth gaps) of the user. For example, the user may move the floss receivers 305 along the groove 220/220′ (and the rail 230/230′) so as to align the dental floss with the gaps as shown by the image in the impressionable material in the cavity 105 made by the user's teeth.

The engagement of the floss receiver 305 in groove 220/220′ (which may also include the engagement of the rail 230/230′ the indent 350) also prevents the floss receiver 305 from falling out of the multi-tooth flosser, and prevents substantial movement of the floss receiver 305 in the direction transverse to the direction of the groove 220/220′. The floss receivers 305 may be inserted into the groove 220/220′ before the secondary flosser arch 250 is secured to the main flosser arch 200, and/or before the holder 100 is secured to the main flosser arch 200. For example, the floss receivers 305 may be inserted into the groove 220/220′ before stacking and engagement of the components 100/200/250 as shown in FIG. 4A, or engagement of the components 200/250 as shown in FIG. 2C.

The impressionable material in the holder 100 may be used to record the shapes and relative locations of the teeth, so that the multi-tooth flosser can be customized for a particular user. Once this is done, the user may adjust the placement of the floss receivers 305 along the grooves 220 and 220′ of the main flosser arch 200 so as to align the dental floss (which passes through the holes 345 of the floss receivers 305) with the gaps between the user's teeth. The impressionable material holder 100 may also serve as the support base or bottom of the illustrated multi-tooth flosser embodiment.

To make a customized multi-tooth flosser, the user may place the impressionable material into the cavity 105, place the holder 100 into the user's mouth and bite down on the impressionable material in the cavity 105 (while the material is still “impressionable”), to get an impression of his or her mouth. The user may then attach the main flosser arch 200 on top of the impressionable material holder 100 as described above, for example, snapping one set of the spring action couplers 225 into the hole 110. Once the combined structure (made of the components 100/200) is secured, the user may insert into the grooves 220/220′ multiple floss receivers 305 that have floss weaved through them, and slide the floss receivers 305 to align the dental floss with the gaps that are shown by the impression of the user's mouth on the impressionable material in the cavity 105. Note that the dental floss or other stringed material is stretched between the floss receivers in the groove 220 and their counterparts in the groove 220′.

FIG. 4A illustrates assembly of the multi-tooth flosser.

In variants, the user may weave the dental floss through the floss receivers 305 (from the groove 220 to the groove 220′, and back, as needed) after the floss receivers 305 have been inserted into the grooves 220/220′. In variants, the device could allow the user to string floss to through the floss holders or have separate shorter strands of floss or another stringed material tied between each pair of floss receivers 305 in the different grooves 220/220′. In embodiments, the each floss receiver 305 may have two holes perpendicular to each other to allow for easier movement of the dental floss.

Whenever the dental floss is weaved or otherwise attached using the floss receivers 305, the user may tighten the dental floss to make it taut. If the flosser allows the user to string floss through the floss receivers 305 and pull the floss to obtain a new set of string to floss with, the flosser may then have small protrusions that can lock the current strand of floss in place so it stays taut.

After the dental floss is aligned with the in-between teeth gaps, the user may place the secondary flosser arch 250 on top of the main arch 200, and push the secondary flosser arch 250 into attachment with the structure 100/200 by snapping the second set of the spring action couplers 225 into the hole 235, until the two pieces snap into engagement with each other. A multi-tooth flosser, such as the flosser 400 illustrated in FIG. 4B and FIG. 4C, then results. Numeral 460 in the Figures refers to the dental floss stringed between the floss receivers 305 in the opposing grooves 220/220′ of the main flosser arch 200; and numeral 470 refers to the impressionable material in the cavity 105 of the holder 100.

To operate the finished multi-tooth flosser 400, the user may place the device in his or her mouth, and bite down so the stringed dental floss 460 slides through multiple spaces between the user's teeth. In embodiments, the user flosses all the teeth of lower or upper jaw at the same time.

The user may clean the flosser on a regular basis, to prevent bacteria from reentering the user's mouth. There are several ways to clean the flosser, including:

(1) Placing the flosser in a fluid that sanitizes the entire device;

(2) Wiping the flosser with an antibacterial cloth; and

(3) Spraying the device with an antibacterial spray.

The flosser may be made substantially U- or V-shaped. The flosser can have two substantially parallel grooves 220/220′, or a pair of the grooves 220 and a pair of the grooves 220′.

The flosser may be configured and used for flossing animals, disabled people who may have difficulty flossing themselves, and, of course, for self-flossing.

In variants, the spring action couplers are not used, and the components 100/200/250 are attached via different means. In embodiments, the different means of attachment are used along with the spring action couplers. The main flosser arch, the impressionable material holder, and the secondary flosser arch then may not need to have the spring action couplers and corresponding holes. In embodiments, the impressionable material holder, and the secondary flosser arch can attach the three parts to each other with the outside portions of each part, through the center, or in other ways.

The multi-tooth flosser may come preassembled with the floss receivers already inside the main flosser arch and the stringed dental floss already woven through or between the floss receivers.

In embodiments, the multi-tooth flosser does not include the impressionable material. In an example, a user may go to a dentist and request a multi-tooth flosser created specifically for the user's mouth. The dentist may then retrieve impressions of the user's teeth and create a multi-tooth flosser. The flosser may come (1) with multiple pieces allowing for adjustable placement of the floss or stringed material, (2) with multiple pieces without adjustable placement of the floss or stringed material, or (3) made of one piece without adjustable placement of the floss or stringed material.

In different variants, the user can leave the impressionable material in the device or remove it after configuring the device.

Any stringed material may be used in the place of the conventional dental floss.

In variants, the main flosser arch may not have the rail 230 to secure the floss receivers, and the floss receivers may not have corresponding indents; the floss receivers may be secured and allowed to move along the arch through other means. For example, the secondary flosser arch may have a groove 240 (and another groove that is closer to the center of the secondary flosser arch, in a manner analogous to the grooves 220/220′), to hold the floss receivers in place securely and allow them to move along the arch. The groove 240 of the secondary flosser arch may be smaller than the groove 220/220′ of the main flosser arch, to limit the movement of the floss receivers in the direction that is transverse to the arch.

The floss receivers may not need holes to string the dental floss through them. The floss or other stringed material can be pre-attached to the floss receivers, for example.

In variants, the impressionable material holder may be in a shape of a rectangle, may be curved in the shape of a semicircle, may be diamond shaped, or come in other shapes.

After assembly, the multi-tooth flosser may be used with the main flosser arch, the impressionable material holder, and the secondary flosser arch attached or it may be used without the impressionable material holder.

In embodiments, the flosser includes a vibrating mechanism to make the act of flossing more effective.

As shown in the Figures, the secondary flosser arch and/or the main flosser arch may have a shorter inner wall with a groove (designated as 220′), to allow for the stringed material to be weave easily onto the flosser. In other embodiments, such inner groove and the wall into which it is built is missing in the main flosser arch and/or the secondary flosser arch; the floss then stretches across the arch, between the floss receivers that have been inserted into the same groove 220.

This document describes in considerable detail the inventive multi-tooth flossers. This was done for illustration purposes only. Neither the specific embodiments of the invention as a whole, nor those of its features limit the general principles underlying the invention. The specific features described herein may be used in some embodiments, but not in others, without departure from the spirit and scope of the invention as set forth herein. Various physical arrangements of components and various step sequences also fall within the intended scope of the invention. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is may be carried out by the claims and their equivalents.

I claim:

1. A multi-tooth flosser comprising:
a base with portions defining a cavity;
material in the cavity showing locations of in-between teeth gaps of a user;
a main flosser arch substantially corresponding to an outline of gums of a jaw, the main flosser arch comprising portions defining a first groove, portions defining a second groove, the second groove opposing the first groove, the main flosser arch comprising a first side and a second side opposite the first side;
a first plurality of floss receivers inserted into the first groove and a second plurality of floss receivers inserted into the second groove;
flossing material stretched between the floss receivers of the first plurality of floss receivers in the first groove and floss receivers of the second plurality of floss receivers in the second groove; and
a secondary flosser arch substantially corresponding to the outline of the gums;
wherein:
the floss receivers of the first and second pluralities of floss receivers are adjusted along the first groove and the second groove so that the flossing material is stretched substantially to coincide with the locations of the in-between teeth gaps in the material;
the base is secured to the first side of the main flosser arch; and
the secondary flosser arch is secured to the second side of the main flosser arch.

2. A multi-tooth flosser according to claim 1, wherein:
the base further comprises portions defining a base through hole;
the main flosser arch further comprises a first set of spring action couplers configured for hole latching, and a second set of spring action couplers configured for hole latching;
the secondary flosser arch further comprises portions defining secondary flosser arch through hole;
the first sets of spring action couplers is latched in the base through hole to secure the base to the main flosser arch; and
the second set of spring action couplers is latched in the secondary flosser arch through hole to secure the secondary flosser arch to the main flosser arch.

3. A multi-tooth flosser according to claim 2, wherein the material is hardened impressionable material with the locations of in-between teeth gaps of the user being marked by the user biting onto the base with the impressionable material in the cavity, before the material hardens.

4. A multi-tooth flosser according to claim 3, wherein each floss receiver of the first and second pluralities of floss receivers comprises portions defining a hole for stringing the flossing material.

5. A multi-tooth flosser according to claim 4, wherein:
the portions defining the first groove include a first rail, the portions defining the second groove comprise a second rail, and each floss receiver of the first and second pluralities of floss receivers further comprises portions defining an indent configured for receiving the first rail or the second rail, to enable movement of said each floss receiver along the first rail or along the second rail.

6. A multi-tooth flosser according to claim 3, further comprising a vibrating mechanism configured to vibrate the flossing material.

7. A multi-tooth flosser according to claim 3, further comprising means for locking the flossing material to keep the flossing material taut.

8. A multi-tooth flosser according to claim 1, wherein:
the base, the main flosser arch, and the secondary flosser arch further comprise means for securing the base to the first side of the main flosser arch, and for securing the secondary flosser arch to the second side of the main flosser arch.

9. A multi-tooth flosser according to claim 8, wherein the material is hardened impressionable material with the locations of in-between teeth gaps of the user being marked by the user biting onto the base with the impressionable material in the cavity, before the material hardens.

10. A multi-tooth flosser according to claim 9, wherein each floss receiver of the first and second pluralities of floss receivers comprises portions defining a hole for stringing the flossing material.

11. A multi-tooth flosser according to claim 10, wherein:
the portions defining the first groove include a first rail, the portions defining the second groove comprise a second rail, and each floss receiver of the first and second pluralities of floss receivers further comprises portions defining an indent configured for receiving the first rail or the second rail, to enable movement of said each floss receiver along the first rail or along the second rail.

12. A multi-tooth flosser according to claim 9, further comprising a vibrating mechanism configured to vibrate the flossing material.

13. A multi-tooth flosser according to claim 9, further comprising means for locking the flossing material to keep the floss taut.
